(19) United States
(12) Patent Application Publication
(10) Pub. No.: US 2020/0244505 A1
(43) Pub. Date: Jul. 30, 2020

(54) CLOCK SYNCHRONIZATION AND OFDM SYMBOL TIMING SYNCHRONIZATION ALGORITHM AND ARCHITECTURE FOR DATA OVER CABLE SERVICE INTERFACE SPECIFICATION (DOCSIS) FULL DUPLEX (FDX) CABLE MODEM (CM) TO ENABLE FAST RECOVERY OF DOWNSTREAM CHANNELS FOLLOWING AN EXTENDED DOWNSTREAM FREEZE

(71) Applicant: Intel Corporation, Santa Clara, CA (US)

(72) Inventors: Thushara Hewavithana, Chandler, AZ (US); Noam Tal, Givataim (IL); Boaz Kol, Hod-Hasharon (IL); Murti Devarakonda, Bengaluru (IN)

(21) Appl. No.: 16/774,349

(22) Filed: Jan. 28, 2020

Related U.S. Application Data
(60) Provisional application No. 62/798,130, filed on Jan. 29, 2019.

(51) Int. Cl. H04L 27/26; H04L 27/00; H04L 27/38

(52) U.S. Cl. CPC H04L 27/2657; H04L 27/2675; H04L 27/3872; H04L 27/0014; H04L 27/2662

(57) ABSTRACT

A modem circuit associated with a communication system is disclosed. The modem circuit comprises a symbol tracking circuit configured to track a symbol timing associated with a downstream (DS) channel associated with the modem circuit, in accordance with a timing offset estimate. In some embodiments, the timing offset estimate comprises a unified timing offset derived based on one or more external channels associated with the modem circuit that is different from the DS channel. The symbol tracking circuit is further configured to apply a sample rate correction to a DS signal associated with the DS channel, based on the timing offset estimate comprising the unified timing offset, and apply a frequency correction to the DS signal, based on a frequency offset estimate comprising a unified frequency offset derived based on the one or more external channels.

### REFERENCE TO RELATED APPLICATIONS

This application claims the benefit of provisional Application No. 62/798,130, filed Jan. 29, 2019, entitled “CLOCK SYNCHRONIZATION AND OFDM SYMBOL TIMING SYNCHRONIZATION ALGORITHM AND ARCHITECTURE FOR DOCSIS FDX CM TO ENABLE FAST RECOVERY OF DOWNSTREAM CHANNELS FOLLOWING AN EXTENDED DOWNSTREAM FREEZE”, contents of which are herein incorporated by reference in their entirety.

### FIELD

The present disclosure relates to the field of full duplex (FDX) communication systems, and in particular, to a system and method for enabling fast recovery of downstream channels following an extended downstream freeze in FDX communication networks.

### BACKGROUND

The next generation data over cable service interface specification (DOCSIS) standard for Hybrid Fibre Coax (HFC) technology will be based on Full Duplex (FDX). FDX is made possible by natural migration of HFC plant to N+0 architecture, which brings fiber to the last amplifier in the HFC, to increase per Service group capacity. In N+0 architecture, the last amplifier is replaced by a Remote Phy Device (RPD), which implements the physical layer (PHY) and possible some limited media access control (MAC) layer functions of the DOCSIS Cable Modem Termination System (CMTS) headend system. The network which connects remote PHY (RPHY), or the node, to Cable Modems (CMs) is entirely passive in this network architecture and therefore it is possible to have a full duplex (FDX) communication between the RPHY and the CMs.

### BRIEF DESCRIPTION OF THE DRAWINGS

Some examples of circuits, apparatuses and/or methods will be described in the following by way of example only. In this context, reference will be made to the accompanying Figures.

FIG. 1 illustrates a simplified block diagram of a modem circuit associated with a communication system, according to one embodiment of the disclosure.

FIG. 2a and FIG. 2b depicts two possible architectures for the internal recovery loop circuit, according to one embodiment of the disclosure.

FIG. 3 illustrates an example implementation of a modem circuit, according to one embodiment of the disclosure.

FIG. 4 illustrates an example implementation of a modem circuit, according to one embodiment of the disclosure.

FIG. 5 illustrates a flow chart of a method associated with a modem circuit, according to one embodiment of the disclosure.

FIG. 6 illustrates a flow chart of a method associated with a modem circuit, according to one embodiment of the disclosure.

### DETAILED DESCRIPTION

In one embodiment of the disclosure, a modem circuit associated with a communication system is disclosed. The modem circuit comprises a symbol tracking circuit configured to track a symbol timing associated with a downstream (DS) channel associated with the modem circuit, in accordance with a timing offset estimate. In some embodiments, the timing offset estimate comprises a unified timing offset derived based on one or more external channels associated with the modem circuit that is different from the DS channel.

In one embodiment of the disclosure, a modem circuit associated with a communication system is disclosed. The modem circuit comprises a symbol tracking circuit configured to track a symbol timing associated with a downstream (DS) channel associated with the modem circuit, in accordance with timing offset estimate comprising an internal timing offset derived based on the DS channel, during a normal state associated with the DS channel. In some embodiments, the symbol tracking circuit is further configured to track the symbol timing associated with the DS channel, in accordance with the timing offset estimate comprising a unified timing offset derived based on one or more external channels different from the DS channel, during a freeze state associated with the DS channel.

In one embodiment of the disclosure, a method for a modem circuit associated with a communication system is disclosed. The method comprises tracking a symbol timing associated with a downstream (DS) channel associated with the modem circuit, at a symbol tracking circuit, in accordance with a timing offset estimate. In some embodiments, the timing offset estimate comprises a unified timing offset derived based on one or more externals channels associated with the modem circuit that is different from the DS channel.

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” “circuit” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the event that the terms “including”, “includes”, “having”, “has”, “with”, or variants thereof are used in either the detailed description and the claims, such terms are intended to be inclusive in a manner similar to the term “comprising.”

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

As indicated above, it is possible to have a full duplex (FDX) communication between the RPHY and the cable modems (CMs) in N+0 architecture. To implement Full Duplex without burdening CM with very difficult echo cancellation requirements, the Cable Modems (CMs) in a cable network are partitioned into Interference Groups (IGs). An Interference Group is a set of Cable Modems in which upstream and downstream signals of CMs interfere with each other. Once IGs have been identified, the CMTS/RPHY can schedule Full-Duplex upstream (US) and downstream (DS) packets to Cable Modems so that they do not collide in time and frequency. Within the same IG, CMs operate in Frequency domain duplex (FDD). Hence the CM will only see high power upstream (US) echo in adjacent FDX channels. There will be some adjacent leakage interference (ALI) in DS channel inband. This makes the echo cancellation requirements on CM less strict compared to RPHY end, where RPHY has to cancel co-channel high power US echo inband DS channel. Full Duplex operation is achieved from whole HFC node point of view by allowing CMs in different IGs transmitting and receiving in the same frequency band.

FDX band in DOCSIS is divided into up to 3 sub-bands. Each band is denoted as a resource block (RB). As mentioned above, CMs in same IG operates in FDD. For example, CMs in IG1 could be assigned resource blocks UDD, meaning these CMs uses first FDX channel as upstream (US) and the second and third channels as downstream (DS). Here we refer to UDD as the resource block allocation (RBA) direction set of IG1. Another IG, IG2 could have RBA direction set DUU. Hence, from Node point of view, between IG1 and IG2, we achieve full duplex operation. CMTS/RPHY allocates RBAs for IGs based on their US and DS throughput demands. In FDX DOCSIS, RBA is allowed to be dynamic to allow CMTS to adapt to different throughput demands by CMs in the network. CMTS/RPHY uses RBA switching to achieve load balancing.

In FDX operation, in order to support RBA switching, the CM has to be able to switch a DS channel to an upstream (US) channel when there is a resource block reallocation and then possible return to DS after some time. During the US burst, CM downstream is not able to receive clean signal, as channel is swamped by high power US echo. Hence CM needs to be able to freeze the DS state (i.e. channel estimate, echo cancellation state, phase errors, timing/frequency loop filter status) just before US burst start and be able to lock into DS once the US burst has ended. The time taken by DS lock, once the US has ended, has to be minimized to have efficient RBA switching. For example, consider CM starting with UUD RBA and change to UUU for few seconds to support a speed test. Following this CM return to its previous RBA of UUD. During UUU RBA, CM can protect the CM DS status by freezing key DS parameters, such as channel estimates and synchronization parameters (time/frequency) offsets. However, CM has to still maintain symbol timing and orthogonal frequency division multiplexing (OFDM) trigger point associated with the frozen DS channel if the CM were to use the saved downstream status to quickly recover DS of third channel when CM returns to UUD RBA. In addition to that, CM has to compensate for any minor changes in symbol timing. In some embodiments, the OFDM trigger point comprises a point where the CM starts counting samples for an OFDM symbol, that is, the beginning of the symbol (or the symbol boundary).

In DOCSIS FDX, CMTS uses MAC messaging to signal impending RBA changes to CM. Based on these signals, for a given FDX sub-band, CM will promptly freeze DS status at least one symbol before US start and only unfreeze DS once US burst has ended. During the freeze time of the DS, the CM has to keep track of symbol timing. Hence the symbol timer is kept freewheeling to keep track of the OFDM trigger point. OFDM Trigger point is advanced from symbol to symbol by counting the correct number of samples in the OFDM symbol,

Number of Samples in OFDM symbol=N+N_{G} (1)

Where N is the number of samples in OFDM symbol useful duration (i.e. FFT size), and N_{G} is the number of samples in guard interval between OFDM symbols (also known as cyclic prefix in classic OFDM modulation used in DOCSIS FDX). CM also keep track of OFDM symbol number within the Physical Layer Control (PLC) frame. This allows CMs to know the OFDM PHY parameters, such as symbol number, scattered pilot phase when retuning from freeze state.

In the above scenario, the DS channel is moved into a frozen state due to an RBA switch. Alternately, in other embodiments, the DS channel may be moved into a frozen state, due to other factors affecting the DS channel, for example, due to a prolonged interference affecting the DS channel. In this case, the CM may use channel freezing to protect the DS channel status during the interference period, and recover the channel, based on the frozen DS parameters. Further, freezing the DS channel and recovering the frozen DS channel based on saved DS parameters is not limited to cable modem applications. Rather, freezing the DS channel and recovering the frozen DS channel based on saved DS parameters is applicable to modem circuits (e.g., receiver circuits) associated with any communication system.

In current implementations of modem circuits, symbol timing is tracked during a DS freeze using the saved timing information associated with the frozen DS channel. In particular, a frozen timing offset from an internal Timing Recovery Loop (TRL) of the DS channel itself is used to keep track of OFDM symbol timing for a given channel. In some embodiments, the timing offset is indicative of an error in a receiver sample rate (i.e., the sample rate at the modem circuit) with respect to a sample rate at a transmitter. Any error in this saved timing offset (or saved sample rate offset) is accumulated over the freeze time resulting in a trigger point drift. This limits the time the DS channel can stay in freeze state for a quick recovery. For example, consider a scenario where frozen sample rate is fraction faster than CMTS (i.e., the transmitter) reference rate (204.8 MHz). In this case OFDM symbol length, T_{S}, is slightly longer than the period covered by N+N_{G} samples at receiver during freeze event. Assume receiver symbol duration during freeze is T_{S}^{′}, where T_{S}<T_{S}. After n symbol freeze event, OFDM trigger point get shifted left by n(T_{S}−T_{S}^{′}). Conversely, if the receiver sample rate was slower than CMTS reference rate, then we will observe right shift of OFDM trigger point.

For extended freeze times of the order of multiple of seconds, trigger point drift mentioned above could be many samples—even 100 s. In such scenarios, the modems have to do a reacquisition of downstream each time RBA changed to downstream. If this takes 200 ms, which is what current modems require, we are losing 200 ms out of 1 second DS period, thereby causing 20% throughput loss for the CM. Therefore, in such scenarios, the maximum freeze time of a DS channel is limited due to the trigger point drift as indicated above. For example, assume the error in saved timing offset is 0.02 PPM and we want to limit the timing drift during DS freeze to 2 OFDM samples. Two samples at 204.8 MHz rate is dt=1/204.8e6*2 Sec. Hence the maximum freeze time would be (2/204.8e6)/0.02e-6=0.4883 Sec. Hence maximum freeze time CM can tolerate is limited to about half seconds. For efficient operation in FDX, modem circuits may need to support extended freeze times and still be able to recover the DS channel quickly at the end of DS freeze.

In order to overcome the above disadvantages, a modem circuit configured to track a symbol timing associated with a DS channel based on timing information associated with one or more external channels associated with the modem circuit that is different from the DS channel is proposed herein. In some embodiments, the one or more external channels comprise other channels associated with the modem circuit that are different from the DS channel. In particular, a modem circuit configured to track a symbol timing associated with the DS channel, based on a unified timing offset derived based on the timing information associated with the one or more external channels that are active (not frozen) is disclosed. In some embodiments, deriving the unified timing offset based on the one or more external channels is based on the idea that the timing offset associated with each of the DS channels associated with the modem circuit is the same.

In some embodiments, the modem circuit is further configured to generate a plurality of sample rate corrected OFDM samples by applying a sample rate correction to an OFDM signal associated with the DS channel, in accordance with the unified timing offset. In addition in some embodiments, the modem circuit is configured to apply the frequency correction to the OFDM signal by processing the plurality of sample rate corrected OFDM samples, based on a frequency offset estimate comprising a unified frequency offset derived based on the one or more external channels, thereby generating a plurality of OFDM output samples. In some embodiments, the OFDM output samples comprise sample rate/frequency corrected samples. In some embodiments, the unified frequency offset is derived from the unified timing offset, in accordance with a predefined time frequency offset relation, further details of which are given in embodiments below.

In some embodiments, the modem circuit is configured to track the symbol timing of the DS channel and/or generate the sample rate/frequency corrected samples based on the unified timing offset/unified frequency offset associated with the one or more external channels, during a freeze state associated with the DS channel. In such embodiments, the modem circuit may be configured to track the symbol timing of the DS channel and/or generate the sample rate/frequency corrected samples based on an internal timing offset/internal frequency offset associated with the DS channel itself, during a normal state associated with the DS channel. In some embodiments, the normal state refers to a state when the channel is not frozen.

In some embodiments, utilizing live unified timing information associated with the active external channels to track symbol timing, during a freeze time of the DS channel, reduces the trigger point drift issues associated with using the frozen time offset associated with the frozen DS channel, thereby enables the modem circuit to quickly recover the DS channel after the freeze state. Further, utilizing live unified timing information associated with the active external channels to track symbol timing enables to extend CM freeze time by couple of order of magnitude (since the unified timing offset is independent of the freeze time associated with the DS channel) and still enable CM to recover downstream within few OFDM symbols.

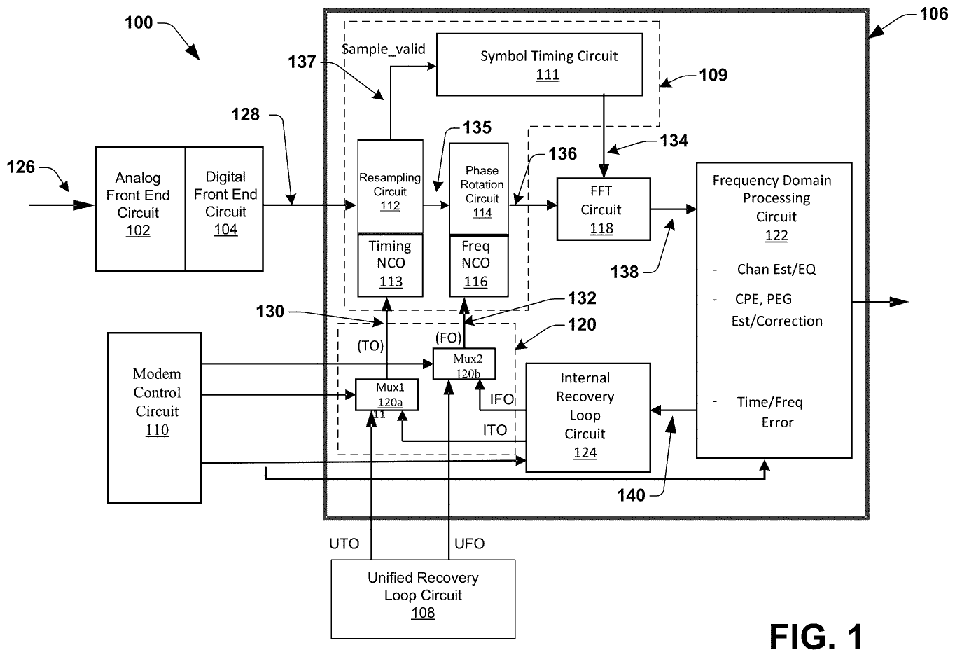

FIG. 1 illustrates a simplified block diagram of a modem circuit 100 associated with a communication system, according to one embodiment of the disclosure. In some embodiments, the communication system may support full duplex (FDX) communications. In some embodiments, the modem circuit 100 support communication in an FDX band and a non-FDX band. In some embodiments, the modem circuit 100 comprises a cable modem (CM) circuit associated with a cable modem communication system. However, in other embodiments, the modem circuit 100 may comprise a receiver circuit associated with any other communication system. The modem circuit 100 comprises an analog front end (AFE) circuit 102, a digital front end (DFE) circuit 104, a demodulator circuit 106, a unified recovery loop circuit 108 and a modem control circuit 110. Although not shown, the modem circuit 100 may comprise other components than explained above.

In some embodiments, the AFE circuit 102 comprises analog and mixed signal processing modules, and is configured to sample a received radio frequency (RF) signal 126. In some embodiments, the modem circuit 100 comprises a full bandwidth capture receiver. In such embodiments, a downstream (DS) spectrum of the RF signal 126 is digitized at the AFE circuit 102 in one go leading to all DS channels in the spectrum subjected to the same timing errors. The DFE circuit 104 is configured to process the full bandwidth digital samples of the received RF signal 126 into a plurality of individual DS channels. In some embodiments, it is assumed that there are no sample rate or frequency offset corrections done in AFE circuit 102 or the DFE circuit 104. In some embodiments, the demodulator circuit 106 is configured to process a DS signal 128 associated with a single DS channel of the plurality of DS channels at the output of the DFE circuit 104. In some embodiments, the DS signal 128 is at baseband frequency, after down conversion at the DFE circuit 104. Although not shown, the modem circuit 100 may comprise a plurality of demodulator circuits configured to process DS signals associated with the plurality of DS channels, respectively.

In some embodiments, the demodulator circuit 106 comprises a symbol tracking circuit 109 configured to track a symbol timing associated with the DS channel associated with the demodulator circuit 106. In some embodiments, the DS channel is associated with an FDX band. Alternately, in other embodiments, the DS channel may be associated with a non-FDX band. In some embodiments, the symbol tracking circuit 109 is configured to track the symbol timing associated with the DS channel, in accordance with a timing offset estimate 130. In some embodiments, the timing offset estimate 130 is indicative of an error in a receiver sample rate (i.e., the sample rate of the DS signal 128 associated with the DS channel at the modem circuit 100) with reference to a transmitter sample rate. In some embodiments, the symbol tracking circuit 109 is further configured to apply a sample rate correction to the DS signal 128 associated with the DS channel, based on the timing offset estimate, thereby generating a plurality of sample rate corrected DS samples 135. In some embodiments, the DS signal 128 comprises an orthogonal frequency domain multiplexing (OFDM) signal. Further, the symbol tracking circuit 109 is configured to apply a frequency correction to the DS signal 128 by processing the plurality of sample rate corrected samples 135, based on a frequency offset estimate 132, thereby generating a plurality of DS output samples 136, that forms a processed DS signal 136. In some embodiments, the frequency offset estimate 132 is indicative of an error in a carrier frequency of the DS signal 128 associated with the DS channel at the modem circuit 100 with reference to a transmitter carrier frequency. In some embodiments, the plurality of DS output samples 136 comprise sample rate/frequency corrected samples.

In some embodiments, the symbol tracking circuit 109 comprises a resampling circuit 112 configured to apply the sample rate correction to the DS signal 128 associated with the DS channel, based on the timing offset estimate 130, thereby generating the plurality of sample rate corrected DS samples 135. In some embodiments, the resampling circuit 112 is further configured to generate a sample valid signal 137 comprising a plurality of sample valid pulses indicative of a timing when the plurality of sample rate corrected DS samples 135 are to be generated. In some embodiments, the resampling circuit 112 is configured to generate the sample valid signal 137 based on utilizing a timing numerically controller oscillator (NCO) circuit 113 that determines when to generate the sample rate corrected DS samples 135, based on the timing offset estimate 130. In some embodiments, the timing NCO circuit 113 updates (accumulates) the timing offset to be applied to each sample of the DS signal 128.

In some embodiments, the symbol tracking circuit 109 further comprises a phase rotation circuit 114 configured to apply the frequency correction to the DS signal 128 by processing the plurality of sample rate corrected DS samples 135, based on the frequency offset estimate 132, thereby generating the plurality of DS output samples 136. In some embodiments, the phase rotation circuit 114 is configured to apply the frequency correction to the DS signal 128 by applying a multiplicative phasor to each of the plurality of sample rate corrected DS samples 135, in order to apply the frequency correction to the DS signal 128. In some embodiments, the symbol tracking circuit 109 further comprises a frequency NCO circuit 116 that generates the multiplicative phasor based on the frequency offset estimate 132. In some embodiments, the symbol tracking circuit 109 further comprises a symbol timing circuit 111 configured to track the symbol timing of the DS channel (in order to keep track of the symbol boundaries) based on counting the plurality of sample valid pulses associated with the sample valid signal 137 from the resampling circuit 112. In some embodiments, the trigger point (or the symbol boundary) is advanced from symbol to symbol by counting the sample valid pulses in the sample valid signal 137 that corresponds to the correct number of samples, N+N_{G}, in the OFDM symbol associated with the DS signal, where N is the number of samples in OFDM symbol useful duration (i.e. FFT size), and N_{G} is the number of samples in guard interval between OFDM symbols

In some embodiments, the demodulator circuit 106 further comprises a fast Fourier transform (FFT) circuit 118 configured to perform a discrete Fourier transform (DFT) on the processed DS signal 136 to convert the processed DS signal 136 from time-domain to frequency domain, thereby forming a frequency-domain DS signal 138. In some embodiments, the demodulator circuit 106 further comprises a frequency domain processing (FDP) circuit 122 configured to process frequency domain OFDM samples associated with the frequency domain DS signal 138, and determine a timing/frequency error 140 comprising a frequency error eΔf and/or a timing error eΔt associated with the frequency domain DS signal 138. In some embodiments, the frequency error eΔf is indicative of an error in a carrier frequency of the DS signal 128 associated with the DS channel with reference to a transmitter carrier frequency. Similarly, the timing error eΔt is indicative of an error in a sample rate of the DS signal 128 associated with the DS channel with reference to a transmitter sample rate.

In some embodiments, the FDP circuit 112 is further configured to perform channel estimation, common phase error (CPE) estimation, phase error gradient (PEG) estimation etc. based on the frequency domain DS signal 138. In some embodiments, the FDP circuit 122 is configured to determine the timing/frequency error 140 using phase information carried in continuous pilots (CPs) in OFDM signal (i.e., the frequency domain DS signal 138). In some embodiments, the demodulator circuit 106 further comprises an internal recovery loop circuit 124 configured to generate an internal timing offset ITO and an internal frequency offset (IFO) associated with the DS signal 128, based on the timing/frequency error 140. In some embodiments, the internal recovery loop circuit 140 may comprise filter circuits configured to filter out the timing error eΔt and/or the frequency error eΔf associated with the timing/frequency error 140, in order to generate the ITO and the IFO.

In some embodiments, the modem circuit 100 further comprises a unified recovery loop circuit 108 configured to generate a unified timing offset (UTO) and a unified frequency offset (UFO). In some embodiments, the UTO and the UFO are generated at the unified recovery loop circuit 108, based on timing and/or frequency information associated with one or more external channels that is different from the DS channel associated with the demodulator circuit 106. In some embodiments, the one or more external channels comprise a DS primary channel in a non-FDX band (e.g., DOCSIS primary channel) associated with the modem circuit 100. In some embodiments, the DS primary channel comprises a predefined channel that is always active (never frozen). The DS Primary channels do not participate in FDX operation and therefore are not subjected RBA switching. Hence, the DS primary channel is always active and always can provide live (not frozen) Time/Frequency Offset estimates. Alternately, in other embodiments, the one or more external channels comprise one or more active DS channels associated with the modem circuit 100. In some embodiments, the active DS channels comprise DS channels that are not in the frozen state. In some embodiments, the one or more active DS channels include the DS primary channel. Further, in some embodiments, the one or more external channels comprises one or more non-FDX DS channels associated with the modem circuit 100. In some embodiments, the one or more non-FDX DS channels include the DS primary channel.

In some embodiments, the timing offset estimate 130 and the frequency offset estimate 132 utilized by the symbol tracking circuit 109 comprises the UTO and UFO respectively. In such embodiments, the symbol tracking circuit 109 is configured to track the symbol timing 134 associated with the DS channel, in accordance with the timing offset estimate 130 comprising the UTO. In particular, in such embodiments, the resampling circuit 112 is configured to generate the sample valid signal 137, based on the UTO and the symbol timing circuit 111 is configured to determine the symbol timing based on the sample valid signal 137. Further, the resampling circuit 112 is configured to apply the sample rate correction to the DS signal 128 associated with the DS channel, based on the timing offset estimate 130 comprising the UTO. In addition, in such embodiments, the phase rotation circuit 114 is configured to apply the frequency correction to the DS signal 128 by processing the plurality of sample rate corrected DS samples 135, based on the frequency offset estimate 132 comprising the UFO.

In some embodiments, the symbol tracking circuit 109 is configured to track the symbol timing 134 associated with the DS channel and apply the sample rate correction to the DS signal 128, based on the UTO, and apply the frequency correction to the DS signal 128 based on the UFO, only during a freeze state associated with the DS channel. Alternately, in other embodiments, the symbol tracking circuit 109 is configured to utilize the UTO and UFO as the timing offset estimate 130 and the frequency offset estimate 132, respectively, during both the freeze state and normal state of the DS channel. In some embodiments, utilizing the UTO and UFO during the freeze state of the DS channel, enables the symbol tracking circuit 109 to track the symbol timing using live (not frozen) time offset/frequency offset estimates, thereby avoiding the timing drift associated with the OFDM trigger point as explained above.

In some embodiments, during the freeze state of the DS channel, the DS signal 128 may not be received (or may not be available) at the symbol tracking circuit 109. In such embodiments, the sample rate correction based on the UTO and the frequency correction based on the UFO may not be performed at the symbol tracking circuit 109 during freeze time. However, even in such embodiments, the resampling circuit 112 is configured to generate the sample valid signal 137, based on the UTO and the symbol timing circuit 111 is configured to determine the symbol timing based on the sample valid signal 137.

In the embodiments where the UTO and UFO are utilized only during the freeze state, the symbol tracking circuit 109 is configured to track the symbol timing 134 associated with the DS channel, in accordance with the timing offset estimate 130 comprising the ITO from the internal recovery loop circuit 124, during a normal state of the DS channel. In particular, in such embodiments, during the normal state of the DS channel, the resampling circuit 112 is configured to generate the sample valid signal 137 (that is utilized to determine the symbol timing 134), based on the ITO. Further, the resampling circuit 112 is configured to apply the sample rate correction to the DS signal 128 associated with the DS channel, based on the timing offset estimate 130 comprising the ITO, during the normal state of the DS channel. In addition, in such embodiments, the phase rotation circuit 114 is configured to apply the frequency correction to the DS signal 128 by processing the plurality of sample rate corrected DS samples 135, based on the frequency offset estimate 132 comprising the IFO, during the normal state of the DS channel.

In some embodiments, the demodulator circuit 106 further comprises a multiplexer circuit 120 configured to couple to the internal recovery loop circuit 124 and the unified recovery loop circuit 108. In some embodiments, the multiplexer circuit 120 is configured to provide the ITO/IFO from the internal loop recovery circuit 120 to the symbol tracking circuit 109 during a normal state of the DS channel and provide the UTO/UFO from the unified recover loop circuit 124 to the symbol tracking circuit 109, during a freeze state of the DS channel. Alternately, in some embodiments, the multiplexer circuit 120 may be configured to provide the UTO/UFO from the unified recover loop circuit 124 to the symbol tracking circuit 109, during both the normal state and the freeze state of the DS channel. In some embodiments, the multiplexer circuit 120 is configured to provide the UTO/UFO or the ITO/IFO to the symbol tracking circuit 109, based on instructions from the modem control circuit 110.

In some embodiments, the modem control circuit 110 manages function and integrity of the modem circuit 100. For example, in some embodiments, when the DS channel is running as normal in DS, the modem control circuit 110 instructs the internal recovery loop circuit 120 to work as normal and controls MUX1 120a and MUX2 120b to take their inputs from the internal recovery loop circuit 120. And when the DS channel is switched to the frozen state, the modem control circuit 110 instructs the internal recovery loop circuit 120 to freeze, and controls the MUX1 120a and the MUX2 120b to take time and frequency offset values from unified recovery loop circuit 108. Alternately, in some embodiments, the modem control circuit 110 controls the MUX1 120a and the MUX2 120b to take time and frequency offset values from unified recovery loop circuit 108, during both the normal state and the freeze state of the DS channel. In some embodiments, the modem control circuit 110 is further configured to determine a freeze state of the DS channel and provide instructions to freeze the FDP circuit 122, during the freeze state. In some embodiments, freezing the FDP circuit 112 comprises saving one or more parameters comprising the channel estimates, CPE, PEG etc. of the frozen DS channel, to be utilized when the DS channel is transitioned back to the normal state.

In some embodiments, utilizing the UTO from the unified recovery loop circuit 108 to track the symbol timing of the DS channel associated with the demodulator circuit 106 is based on the idea that all DS channels associated with a full bandwidth capture receiver (e.g., the modem circuit 100) comprises the same timing offset (since all the DS signals associated with the modem circuit 100 are processed by the same AFE 102/DFE 104). In addition, the frequency offset of a DS channel is proportional to timing offset and the center frequency of the DS channel, as can be fully appreciated below. Therefore, in some embodiments, the UFO (or the frequency offset to be provided to the symbol tracking circuit 109) may be derived based on the UTO, in accordance with the center frequency of the DS channel associated with the demodulator circuit 106.

Consider analytic representation of a signal (e.g., the received RF signal 126) at the modem input for a DS channel, s(t)e^{2πjf}^{_{c}}^{t}, where s(t) is the baseband signal and f_{c} is the carrier (RF) frequency. Let the sample period at receiver be T′ and the sample period at the Node be T, where sample rate offset (or the timing offset) is

$$\begin{matrix}Δ T = \frac{T}{{T}^{′}} - 1. & \\ \hat{s} ( nT ) = s ( nT ) {e}^{- 2 π j \hat{{f}_{c}} nT ( \frac{T}{{T}^{′}} - 1 )} & ( 4 )\end{matrix}$$

Sampled signal at the modem input,

y(nT′)=S(nT′)e^{2πjf}^{_{c}}^{nT′}(2)

Down convert to baseband for demodulation to form the DS signal 128 (this happens in DFE circuit 104),

ŝ(nT′)=s(nT′)^{e2πjf}^{_{c}}^{nT′}e^{-2πjf}^{_{c}}^{nT} (3)

Re-sampling of the signal at resampling circuit 112 is expected to convert the DS signal 128 into Node sample period T. Conceptually, this can be done by first converting the signal to continuous time by setting n=t/T′, and then resample by setting t=nT.

Hence the frequency offset due to timing offset is given by,

Δf=−f_{c}ΔT (5)

Frequency offset normalized the sample rate,

$$\frac{1}{T} ,$$

is given by,

[symbol]

=−\hat{f}_{c}ΔT (6)

Where normalized carrier frequency with respect to sample rate is given by \hat{f}_{c}=f_{c}T and normalized frequency offset is given by, [symbol] =ΔfT. In some embodiments, the equation (6) above may be referred to as a time frequency offset relation. Hence, from equation (6) above, it can be seen that the frequency offset for the DS channel can be derived based on the timing offset and vice versa.

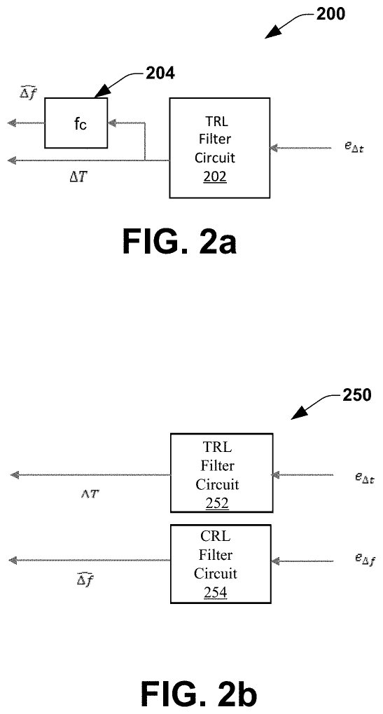

FIG. 2a and FIG. 2b depicts two possible architectures for the internal recovery loop circuit 124, derived based on the time frequency offset relation in equation (6) above. In some embodiments, the architectures in FIG. 2a and FIG. 2b may also be applicable to the unified recovery loop circuit 108 in FIG. 1. In particular, FIG. 2a depicts an internal recovery loop circuit 200 comprising a single timing recovery loop (TRL) filter circuit 202 that generates both the internal timing offset (ITO) ΔT and the internal frequency offset (IFO) [symbol] . In particular, the TRL filter circuit 202 applies some standard filtering techniques to the timing error e_{Δt} to generate the ITO ΔT. Further, the internal recovery loop circuit 200 comprises a frequency offset determination circuit 204 configured to derive the IFO [symbol] from the ITO ΔT, in accordance with the predefined time frequency offset relation in equation (6) above. Further, FIG. 2b depicts an internal recovery loop circuit 250 comprising independent loop filter circuits to generate the ITO ΔT and the IFO [symbol] , without utilizing the predefined time frequency offset relation in equation (6) above. In particular, the internal recovery loop circuit 250 comprises a TRL filter circuit 252 that generates the ITO ΔT based on the timing error e_{Δt} and a carrier frequency loop (CRL) filter circuit 254 that generates the IFO [symbol] based on the frequency error e_{Δf} In some embodiments, utilizing a single TRL filter circuit as in FIG. 2a leads to simpler architecture and better accuracy.

Referring back to FIG. 1, there are multiple ways for the FDP circuit 122 to derive the time and frequency error metrics, e_{Δt} and e_{Δf}, that are needed to drive TRL and CRL Loops (i.e., the internal recovery loop circuit 124). Following section gives algorithm based on phase of frequency domain pilots found in downstream OFDM signals (e.g., DOCSIS 3.1 downstream OFDM signals). These continuous pilots (CPs) can be used to work out phase difference between pilots in two successive symbols. Mean phase difference is proportional to frequency error e_{Δf} whereas gradient in frequency direction of phase difference is proportional to timing (sample rate) error e_{Δt}.

Consider Continuous Pilot (CP) in an OFDM signal with following parameters,

OFDM useful symbol period T_{U} and guard interval (cyclic prefix) T_{G}
Full OFDM symbol duration T_{S}=T_{U}+T_{G}
Natural OFDM sample period T and DFT length for OFDM modulation N
Number of samples in guard interval N_{G}
Hence T_{U}=T×N, and T_{G}=T×N_{G}
RF center frequency applied to OFDM signal at transmitter is f_{c}
Receiver (i.e., the modem circuit 100) sample period (converted to OFDM natural rate) is T′
Hence the normalized sample rate offset between CM and the reference rate at Node,

$$Δ T = \frac{T}{{T}^{′}} - 1.$$

Time domain representation of continuous pilot (CP) at sub-carrier index K for OFDM symbol L>0 can be written as,

$${s}_{L , K} ( t ) = {e}^{2 π j \frac{K}{N T} ( t - {LT}_{S} )} {e}^{2 π j {f}_{c} t} for ( L - 1 ) {T}_{S} - {T}_{G} < t \leq {LT}_{S} - {T}_{G} \qquad ( 7 )$$

Without loss of generality assume we start sampling signal at t=0, at the beginning of guard interval of OFDM symbol 0. Assume sample rate error is small enough to not drift the OFDM symbol timing beyond the symbol boundaries (i.e, No inter symbol interference). Then the sampled OFDM symbol L at Receiver OFDM natural sample rate is given by,

$${s}_{L , K} ( n ) = {e}^{2 π j \frac{K}{N T} ( {LT}^{′} + {nT}^{′} - {LT}_{s} )} {e}^{2 π j {f}_{c} ( {LT}_{S}^{′} + {nT}^{′} )} for n = 0 , … , N - 1 \qquad ( 8 )$$

Receiver applies digital down conversion, at the DFE circuit 104, based on prior knowledge of carrier frequency, f_{c}, which is signaled to modem circuit 100 as part of PHY layer signaling. Normalized carrier frequency with respect to transmitter reference sample rate is given by \hat{f}_{c}=fT.

Down converted samples based on normalized carrier frequency offset, as seen at input to the FFT circuit 118, assuming no time and frequency offset correction done at Resampling circuit 112 and the Phase rotation circuit 114,

$$\begin{matrix} {s}_{L , K} ( n ) = {e}^{2 π j \frac{K}{N T} ( {LT}_{S}^{′} - {nT}^{′} - {LT}_{S} )} {e}^{2 π j {f}_{c} ( {LT}_{S}^{′} - {nT}^{′} )} {e}^{- 2 π j \hat{{f}_{c}} ( L ( N + {N}_{G} + n ) )} & ( 9 a ) \\ {s}_{L , K} ( n ) = {e}^{- 2 π j \frac{K}{N} L ( N + {N}_{G} ) ( \frac{Δ T}{1 + Δ T} )} {e}^{- 2 π j \hat{{f}_{c}} ( N + {N}_{G} ) \frac{Δ T}{1 + Δ T}} {e}^{2 π j \frac{K}{NT} ( {nT}^{′} )} {e}^{- 2 π j \hat{ {f}_{c}} n \frac{Δ}{1 + Δ T}} & ( 9 b )\end{matrix}$$

Frequency domain value of CP at sub-carrier index, K, with absolute frequency of

$$\hat{{f}_{c}} + \frac{K}{N} ,$$

can be calculated with DFT (at the FFT circuit 118) as follows (OFDM demodulation),

$${S}_{L , K} = {Σ}_{n = 0}^{N - 1} {s}_{L , K} ( n ) {e}^{- 2 π j \frac{K}{N} ( n )} \qquad ( 10 )$$

Substitute s_{L,K}(n) from equation (9b) in (10) and simplify further to get,

$${S}_{L , K} = {S}_{K} {e}^{- 2 π j \frac{K}{N} L ( N + {N}_{G} ) ( \frac{Δ T}{1 + Δ T} )} {e}^{- 2 π j \hat{{f}_{c}} L ( N + {N}_{G} ) \frac{Δ T}{1 + Δ T}} \qquad ( 11 )$$

### Where

$${S}_{K} = {\sum }_{n = 0}^{N - 1} {e}^{2 π j \frac{K}{NT} ( {nT}^{′} )} {e}^{- 2 π j \hat{{f}_{c}} n \frac{Δ T}{1 + Δ T}} {e}^{- 2 π j \frac{K}{N} ( n )} ,$$

is independent of symbol number, L.
Phase increment from symbol L to symbol L+1 for CP at sub-carrier K,

Δθ_{K}=angle(S_{L+1,K}S_{L,K}^{*}) (12)

where Δθ_{K} denotes phase of the complex number we get for conjugate multiplication of continuous pilot value for successive symbols.

$$Δ {θ}_{K} = - 2 π \frac{K}{N} \frac{Δ T}{1 + Δ T} ( N + {N}_{G} ) - 2 π \hat{{f}_{c}} \frac{Δ T}{1 + Δ T} ( N + {N}_{G} ) \qquad ( 13 )$$

In some embodiments, DS channels (e.g., DOCSIS 3.1/FDX DS channels) have set of CPs with cardinality M, where M is at least 16, spread approximately uniform across the channel, K∈{K₀, . . . , K_{M-1}}. Therefore, the equation (13) above can be viewed as a set of 2 tuples, (K,Δθ_{K}), representing a linear distribution of phases Δθ_{K} over K. Gradient of the distribution is

$$- 2 π \frac{Δ T}{N ( 1 + Δ T )} ( N + {N}_{G} )$$

and the intercept is

$$- 2 π \hat{{f}_{c}} \frac{Δ T}{1 + Δ T} ( N + {N}_{G} ) .$$

Gradient is a function of timing offset, ΔT, and intercept is a function of both normalized frequency offset, [symbol] =\hat{f}_{c}ΔT and timing offset ΔT.

There are multiple ways to work out the timing offset ΔT and the frequency offset [symbol] from phase data for CPs, two of which are explained below.
Fit a line though (K,Δθ_{K}) distribution and work out ΔT from Gradient and/or Intercept. This is the approach to be used to decouple time and frequency offset correction. Note the intercept of equation (13) comes from frequency offset introduced by timing offset at carrier frequency of OFDM signal. Hence intercept can be used as frequency error, e_{Δf}, to drive a frequency recovery loop. On the other hand, the Gradient is directly proportional to timing offset. Hence the Gradient can be used as the timing error, e_{Δt}, to drive the timing recovery loop. This leads to loop filter architecture shown in FIG. 2b.
Interpret (13) as

$${Δθ}_{K} = - \frac{Δ T}{1 + Δ T} \{ 2 π \frac{K}{N} ( N + {N}_{G} ) + 2 π \hat{{f}_{c}} ( N + {N}_{G} ) \}$$

and work out ΔT by combining Δθ_{K} over CPs. For example, we can linearly combine Δθ_{K} weighted by sub-carrier indices for CPs. It can be shown this is close to optimal for AWGN channels.

$$\frac{1 + Δ T}{} = \frac{- {Σ}_{K ∈ \{ {K}_{0} , … , {K}_{M - 1} \}} Δ {θ}_{K} ( 2 π \frac{K}{N} ( N + {N}_{G} ) + 2 π \hat{{f}_{c}} ( N + {N}_{G} ) )}{{Σ}_{K ∈ \{ {K}_{0} , … , {K}_{M - 1} \}} {\vert 2 π \frac{K}{N} ( N + {N}_{G} ) + 2 π \hat{{f}_{c}} ( N + {N}_{G} ) \vert}^{2}} \qquad ( 14 )$$

Timing offset obtained this way using CPs for a pair of symbols is still not accurate enough to do a one-shot correction of timing offset. We need to introduce time direction averaging to improve the accuracy. This is achieved by using the timing error estimate above as timing error, e_{Δt}, to drive the feedback timing correction loop as shown in FIG. 2a. For this purpose, the following simplification,

$$\frac{1 + Δ T}{} ≅ ≪ 1 ,$$

may be used.

Derivations given above shows the relationship between the receiver sample rate offset (or time offset) and observed phase rotation in CPs from one OFDM symbol to the next. In modem circuits (for example, the modem circuit 100 in FIG. 1), we do this processing in frequency domain (i.e., in the FDP circuit 122) after the FFT, where the input to the FFT circuit 118 is already being time and frequency offset corrected in Resample/Phase Rotate module. Hence, we only observe the impact of residual time and frequency offsets following sample rate and frequency offset correction. If architecture in FIG. 2-b is used, then the frequency and timing offsets are corrected using two independent loops. Hence, they converge separately although not quite independently because of the link between time and frequency offsets. Hence, we can separately drive CRL and TRL loops using time and frequency error signals. If Architecture in FIG. 2-a is used, then the frequency offset needs to be precisely worked out based on equation (6). This is to make sure residual time and frequency offset still has the same relationship given in equation (6).

Consider the scenario where we have a timing offset of

$$Δ {T}_{1} = \frac{{T}_{1}}{{T}^{′}} - 1$$

being corrected by the resampling circuit 112, but the actual timing offset is ΔT. In the architecture of FIG. 2a, ΔT, need to also drive the frequency correction with [symbol] ₁=\hat{f}_{c}ΔT₁ (i.e. negative of frequency error according to equation (6)). Digital down conversion of OFDM channels happens in DFE. Hence the down conversion by \hat{f}_{c} in equation (3) remain as is. Rewriting the equation (3) with normalized carrier frequency, we get:

$$\hat{s} ( {nT}^{′} ) = s ( {nT}^{′} ) {e}^{2 π j \hat{{f}_{c}} n \frac{{T}^{′}}{T}} {e}^{- 2 π j \hat{{f}_{c}} n} = s ( {nT}^{′} ) {e}^{2 π j \hat{{f}_{c}} n ( \frac{{T}^{′}}{T} - 1 )} \qquad ( 15 )$$

The effect of sample rate and frequency offset correction at Re-sample/Phase Rotate modules can be captured by following modification to equation (4).

$${s}_{1} ( {nT}_{1} ) = {Resample}_{{T}^{′} \to {T}_{1}} \{ s ( {nT}^{′} ) {e}^{- 2 π j \hat{{f}_{c}} n ( \frac{{T}^{′}}{T} - 1 )} \} {e}^{2 π j n \hat{{f}_{c}} Δ {T}_{1}} \qquad ( 16 )$$

To figure out the effect of resample step, the signal is represented as continuous time signal before resample by the new rate,

$$\hat{s} ( t ) = s ( t ) {e}^{2 π j \hat{{f}_{c}} \frac{t}{{T}^{′}} ( \frac{{T}^{′}}{T} - 1 )} \qquad ( 17 )$$

Resampled signals, sample rate T₁, is given below,

$$\hat{s} ( {nT}_{1} ) = s ( {nT}_{1} ) {e}^{2 π j \hat{{f}_{c}} \frac{{nT}_{1}}{{T}^{′}} ( \frac{{T}^{′}}{T} - 1 )} \qquad ( 18 )$$

Substitute (18) in (16) to get resampled and frequency offset corrected signal,

$${s}_{1} ( {nT}_{1} ) = s ( {nT}_{1} ) {e}^{2 π j \hat{{f}_{c}} \frac{{nT}_{1}}{{T}^{′}} ( \frac{{T}^{′}}{T} - 1 )} {e}^{2 π j n \hat{{f}_{c}} ( \frac{{T}_{1}}{{T}^{′}} - 1 )} = s ( {nT}_{1} ) {e}^{2 π j \hat{{f}_{c}} n ( \frac{{T}_{1}}{T} - 1 )} \qquad ( 19 )$$

Note the similarity between equation (15) and (19). It is clear that correcting the frequency offset with [symbol] =\hat{f}_{c}ΔT₁ based on estimated timing offset ΔT₁ maintains the same relationship between the residual time and frequency offsets. Hence the time and frequency offset corrections remain consistent. This is a key requirement for the architecture in FIG. 2-a.

Referring back to FIG. 1, the unified recovery loop circuit 108 may be configured to determine the UTO and UFO based on the one or more external channels, differently, in different embodiments. For example, in one embodiment, when the one or more external channels comprise the DS primary channel, the UTO comprises the time offset of the DS primary channel. Alternately, in some embodiments, when the one or more external channels comprise one or more active DS channels, the UTO may comprise a select timing offset associated with any one of the active DS channels. In some embodiments, the timing offsets associated with the one or more active DS channels are weighted according to the channel frequencies and signal-to noise ratio (SNR), thereby enabling to choose the select timing offset. For example, higher the frequency of the DS channel, higher the accuracy of the timing offset. Further, in some embodiments, the unified recovery loop circuit 108 may be configured to determine the UTO as an average of the timing offset associated with the one or more channels. Furthermore, other methods of determining the UTO, based on the one or more channels are also contemplated to be within the scope of this disclosure. In such embodiments, the UFO may be derived based on the UTO, in accordance with the equation (6) above.

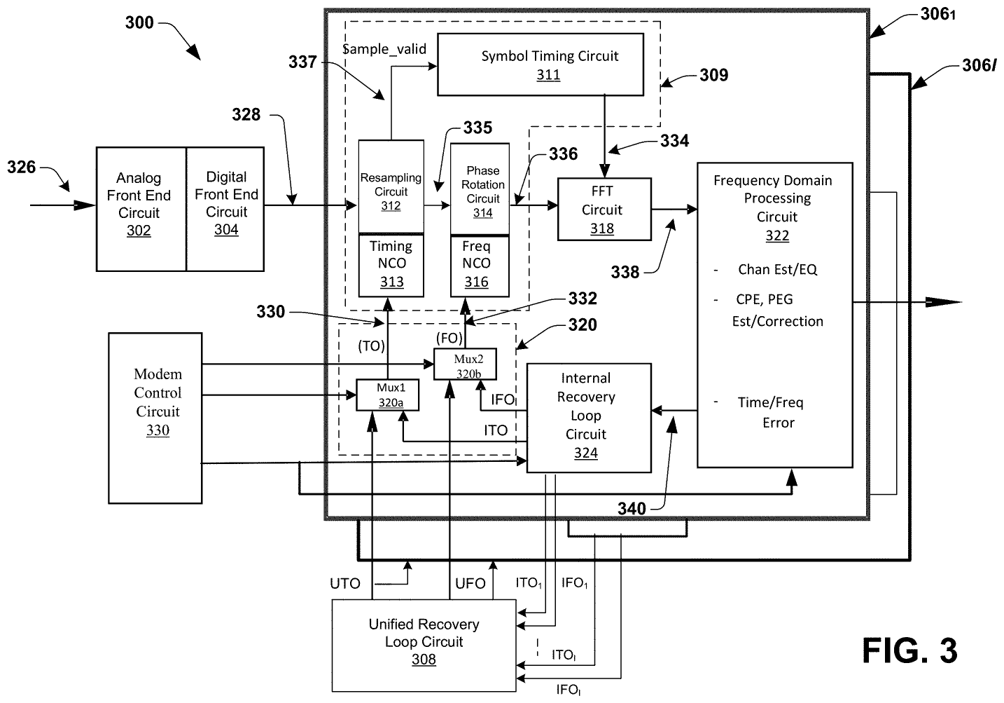

FIG. 3 illustrates an example implementation of a modem circuit 300, according to one embodiment of the disclosure. In some embodiments, the modem circuit 300 comprises one possible way of implementation of the modem circuit 100 in FIG. 1. In some embodiments, the modem circuit 300 comprises a plurality of demodulator circuits 306₁ . . . 306I in order to demodulate a plurality of DS channels. Further, the unified recovery loop circuit 308 is configured to receive the time offsets and the frequency offsets from each of the demodulator circuits 306₁ . . . 306I, in order to determine the UTO. All the other features of the modem circuit 300 is same as the modem circuit 100 in FIG. 1 and is therefore not repeated herein.

Let each demodulator circuit 306₁ . . . 306I has internal TRL/CRL Loops. Each demodulator circuit 306₁ . . . 306I tracks timing and frequency offset independently. Let the time and frequency offsets pair for I DS channels corresponding to I demodulator circuits is given by:

(Δtᵢ,Δfᵢ) for i=1, . . . ,I, (20)

where Δtᵢ is timing error normalized to Demod baseband channel sample period, and Δfᵢ is the frequency offset. In some embodiments, the unified recovery loop circuit 308 is configured to take the Time/Frequency offset estimates from each of the individual demodulator circuits (Δtᵢ, Δfᵢ) for i=1, . . . , I, to form unified Time/Frequency offset estimates. In some embodiments, the unified Time/Frequency offset estimates derived at the unified recovery loop circuit 308 may be configured to drive the timing (and frequency offset correction) of all downstream and upstream channels. At any given time, only the operational downstream channels (active DS channels) will contribute to the unified timing estimation. Frozen channels will momentarily stop contributing until they come alive and converged back.

Algorithm for combining the time and frequency offsets from the K DS channels depends on overall architecture of the modem circuit 300. For example, in the case of full bandwidth capture receivers, single ADC is used in the AFE circuit 102 to digitize the entire downstream spectrum. Hence time offset is the same for all channels (demodulators). Frequency offset is a function of timing offset and center frequency of the channel, as given in equation (6). During a freeze state of a DS channel, we stop taking input from that DS channel to form the unified estimate. Coming out of freeze, we reinitialize time and frequency offset estimates of the corresponding CRL and TRL filter circuits with the unified estimates. Once a DS channel is out of freeze, it is allowed back as a contributor to unified time/frequency offset estimate.

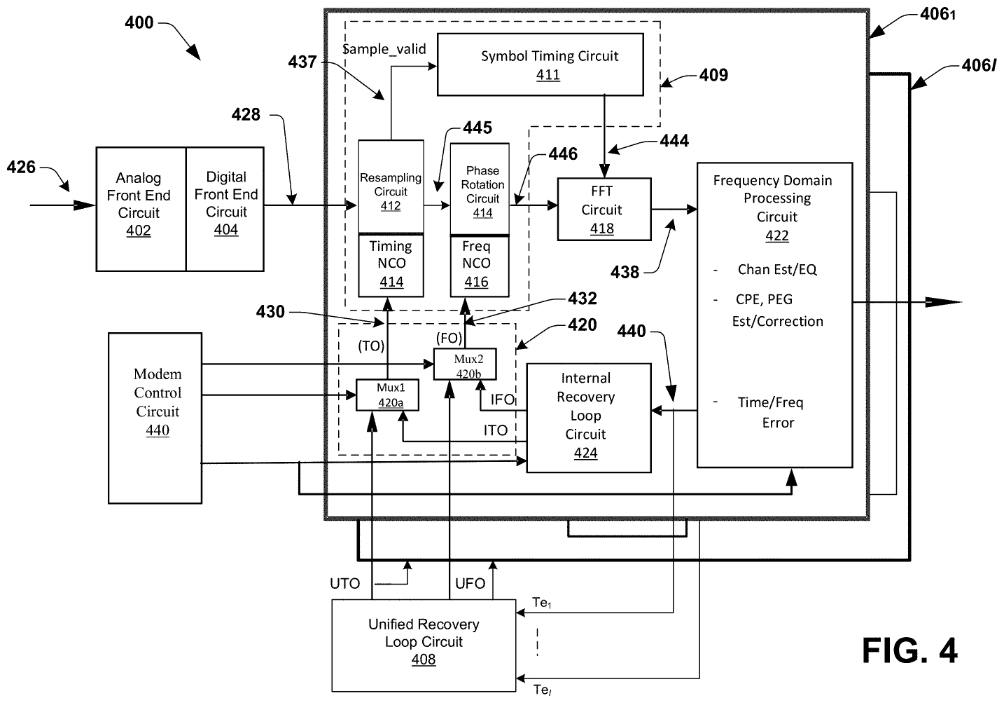

FIG. 4 illustrates an example implementation of a modem circuit 400, according to one embodiment of the disclosure. In some embodiments, the modem circuit 400 comprises another possible way of implementation of the modem circuit 100 in FIG. 1. In some embodiments, the modem circuit 400 comprises a plurality of demodulator circuits 406₁ . . . 406I, in order to demodulate a plurality of DS channels. Further, the unified recovery loop circuit 408 is configured to receive the timing error from each of the demodulator circuits 406₁ . . . 406I, in order to determine the UTO. All the other features of the modem circuit 400 is same as the modem circuit 100 in FIG. 1 and is therefore not repeated herein.

The unified recovery loop circuit 408 comprises a single time recovery loop configured to take time error inputs Te₁ . . . Te_{I} from multiple channels and determine the unified time offset (UTO) based thereon. In some embodiments, a timing error associated with one of the channels is selected, in order to determine the UTO. Frequency offset is a function of timing offset and center frequency of the channel, and is derived from the UTO in accordance with the predefined time frequency offset relation given in equation (6).

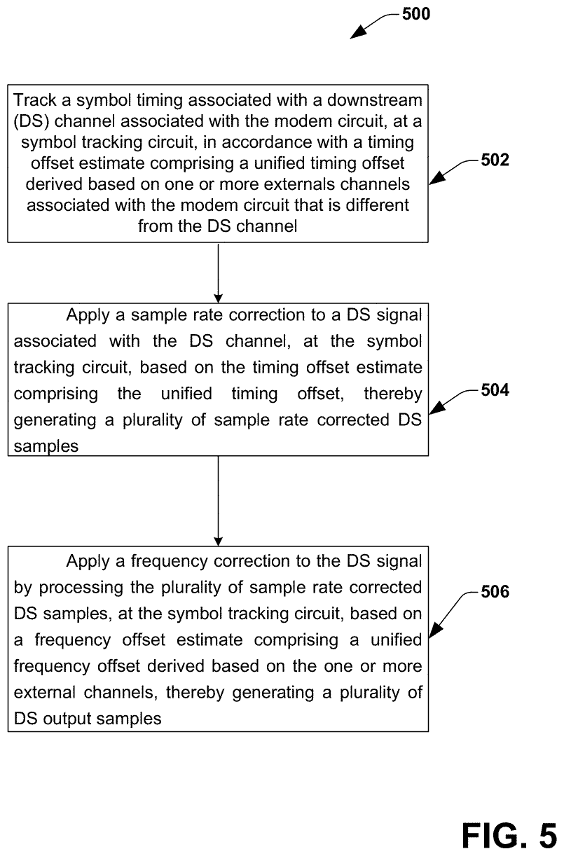

FIG. 5 illustrates a flow chart of a method 500 associated with a modem circuit, according to one embodiment of the disclosure. The method 500 is explained herein with reference to the modem circuit 100 in FIG. 1. However, the method 500 is equally applicable to the modem circuit 300 in FIG. 3 and the modem circuit 400 in FIG. 4. At 502, a symbol timing (e.g., the symbol timing 134 in FIG. 1) associated with a downstream (DS) channel associated with the modem circuit (e.g., the modem circuit 100) is tracked at a symbol tracking circuit (e.g., the symbol tracking circuit 109), in accordance with a timing offset estimate comprising a unified timing offset (e.g., UTO in FIG. 1) derived based on one or more externals channels associated with the modem circuit that is different from the DS channel. In some embodiments, the symbol timing is tracked at the symbol tracking circuit based on a sample valid signal (e.g., the sample valid signal 137 in FIG. 1) generated at the symbol tracking circuit, in accordance with the unified timing offset.

At 504, a sample rate correction to a DS signal (e.g., the DS signal 128 in FIG. 1) associated with the DS channel is applied at the symbol tracking circuit, based on the timing offset estimate comprising the unified timing offset, thereby generating a plurality of sample rate corrected DS samples (e.g., the plurality of sample rate corrected DS samples 135 in FIG. 1). At 506, a frequency correction to the DS signal is applied by processing the plurality of sample rate corrected DS samples, at the symbol tracking circuit, based on a frequency offset estimate comprising a unified frequency offset (e.g., the UFO in FIG. 1) derived based on the one or more external channels, thereby generating a plurality of DS output samples (e.g., the plurality of DS output samples 136 in FIG. 1).

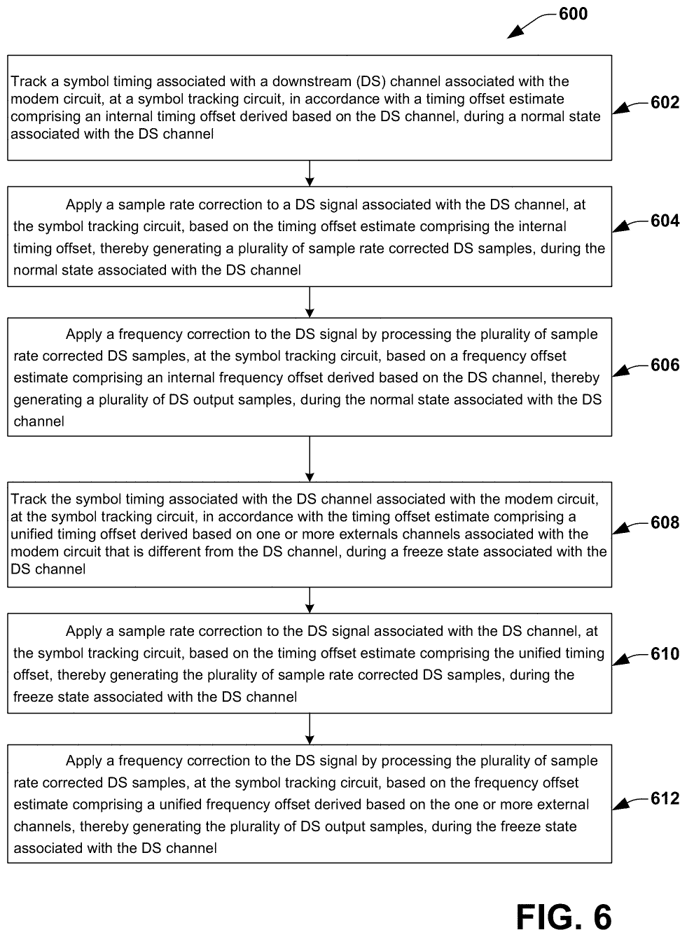

FIG. 6 illustrates a flow chart of a method 600 associated with a modem circuit, according to one embodiment of the disclosure. The method 600 is explained herein with reference to the modem circuit 100 in FIG. 1. However, the method 600 is equally applicable to the modem circuit 300 in FIG. 3 and the modem circuit 400 in FIG. 4. At 602, a symbol timing (e.g., the symbol timing 134 in FIG. 1) associated with a downstream (DS) channel associated with the modem circuit (e.g., the modem circuit 100) is tracked at a symbol tracking circuit (e.g., the symbol tracking circuit 109), in accordance with a timing offset estimate comprising an internal timing offset (e.g., ITO in FIG. 1) derived based on the DS channel, during a normal state associated with the DS channel. In some embodiments, the symbol timing is tracked at the symbol tracking circuit based on a sample valid signal (e.g., the sample valid signal 137 in FIG. 1) generated at the symbol tracking circuit, in accordance with the internal timing offset.

At 604, a sample rate correction to a DS signal (e.g., the DS signal 128 in FIG. 1) associated with the DS channel is applied at the symbol tracking circuit, based on the timing offset estimate comprising the internal timing offset, thereby generating a plurality of sample rate corrected DS samples (e.g., the plurality of sample rate corrected DS samples 135 in FIG. 1), during the normal state associated with the DS channel. At 606, a frequency correction to the DS signal is applied by processing the plurality of sample rate corrected DS samples, at the symbol tracking circuit, based on a frequency offset estimate comprising an internal frequency offset (e.g., the IFO in FIG. 1) derived based on the DS channel, thereby generating a plurality of DS output samples (e.g., the plurality of DS output samples 136 in FIG. 1), during the normal state associated with the DS channel.

At 608, the symbol timing (e.g., the symbol timing 134 in FIG. 1) associated with a downstream (DS) channel associated with the modem circuit (e.g., the modem circuit 100) is tracked at the symbol tracking circuit (e.g., the symbol tracking circuit 109), in accordance with a timing offset estimate comprising a unified timing offset (e.g., UTO in FIG. 1) derived based on one or more externals channels associated with the modem circuit that is different from the DS channel, during a freeze state associated with the DS channel. In some embodiments, the symbol timing is tracked at the symbol tracking circuit based on the sample valid signal (e.g., the sample valid signal 137 in FIG. 1) generated at the symbol tracking circuit, in accordance with the unified timing offset.

At 610, a sample rate correction to the DS signal (e.g., the DS signal 128 in FIG. 1) associated with the DS channel is applied at the symbol tracking circuit, based on the timing offset estimate comprising the unified timing offset, thereby generating a plurality of sample rate corrected DS samples (e.g., the plurality of sample rate corrected DS samples 135 in FIG. 1), during the freeze state associated with the DS channel. At 612, a frequency correction to the DS signal is applied by processing the plurality of sample rate corrected DS samples, at the symbol tracking circuit, based on the frequency offset estimate comprising a unified frequency (e.g., the UFO in FIG. 1) derived based on the one or more external channels, thereby generating the plurality of DS output samples (e.g., the plurality of DS output samples 136 in FIG. 1), during the freeze state associated with the DS channel.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

Example 1 is a modem circuit associated with a communication system, comprising a symbol tracking circuit configured to track a symbol timing associated with a downstream (DS) channel associated with the modem circuit, in accordance with a timing offset estimate; wherein the timing offset estimate comprises a unified timing offset derived based on one or more external channels associated with the modem circuit that is different from the DS channel.

Example 2 is a modem circuit, including the subject matter of example 1, wherein the symbol tracking circuit is further configured to apply a sample rate correction to a DS signal associated with the DS channel, based on the timing offset estimate comprising the unified timing offset, thereby generating a plurality of sample rate corrected DS samples; and apply a frequency correction to the DS signal by processing the plurality of sample rate corrected samples, based on a frequency offset estimate comprising a unified frequency offset derived based on the one or more external channels, thereby generating a plurality of DS output samples.

Example 3 is a modem circuit, including the subject matter of examples 1-2, including or omitting elements, wherein the symbol tracking circuit is configured to track the symbol timing associated with the DS channel and apply the sample rate correction to the DS signal, based on the timing offset estimate comprising the unified time offset, and apply the frequency correction to the DS signal based on the frequency offset estimate comprising the unified frequency offset, during a freeze state associated with the DS channel.

Example 4 is a modem circuit, including the subject matter of examples 1-3, including or omitting elements, wherein the symbol tracking circuit is configured to track the symbol timing associated with the DS channel and apply the sample rate correction to the DS signal, based on the timing offset estimate comprising an internal time offset, and apply the frequency correction to the DS signal based on the frequency offset estimate comprising an internal frequency offset, during a normal state associated with the DS channel, wherein the internal time offset and the internal frequency offset are derived based on the DS channel.

Example 5 is a modem circuit, including the subject matter of examples 1-4, including or omitting elements, further comprising an internal recovery loop circuit configured to determine the internal timing offset and the internal frequency offset based on the DS signal associated with the DS channel.

Example 6 is a modem circuit, including the subject matter of examples 1-5, including or omitting elements, wherein the internal recovery loop circuit comprises an internal timing recovery loop circuit configured to determine the internal timing offset based on a timing error associated with the DS signal; and an internal carrier frequency recovery loop circuit configured to determine the internal frequency offset based on a frequency error associated with the DS signal.

Example 7 is a modem circuit, including the subject matter of examples 1-6, including or omitting elements, wherein the internal recovery loop circuit comprises an internal timing recovery loop circuit configured to determine the internal timing offset based on a timing error associated with the DS signal; and a frequency offset determination circuit configured to derive the internal frequency offset based on the internal timing offset, in accordance with a predefined time frequency offset relation.

Example 8 is a modem circuit, including the subject matter of examples 1-7, including or omitting elements, further comprising a unified recovery loop circuit configured to determine the unified timing offset and the unified frequency offset based on DS signals associated with the one or more external channels.

Example 9 is a modem circuit, including the subject matter of examples 1-8, including or omitting elements, wherein the symbol tracking circuit is configured to track the symbol timing associated with the DS channel based on a sample valid signal generated in accordance with the timing offset estimate.

Example 10 is a modem circuit, including the subject matter of examples 1-9, including or omitting elements, wherein the symbol tracking circuit comprises a resampling circuit configured to apply the sample rate correction to the DS signal associated with the DS channel, based on the timing offset estimate, thereby generating the plurality of sample rate corrected DS samples; and generate the sample valid signal comprising a plurality of sample valid pulses indicative of a timing when the plurality of sample rate corrected DS samples are to be generated, based on the timing offset estimate; and a phase rotation circuit configured to apply the frequency correction to the DS signal by processing the plurality of sample rate corrected DS samples, based on the frequency offset estimate, thereby generating the plurality of DS output samples.

Example 11 is a modem circuit, including the subject matter of examples 1-10, including or omitting elements, wherein the symbol tracking circuit further comprises a symbol timing circuit configured to track the symbol timing of the DS channel based on counting the plurality of sample valid pulses associated with the sample valid signal from the resampling circuit.

Example 12 is a modem circuit, including the subject matter of examples 1-11, including or omitting elements, wherein the one or more external channels comprises a DS primary channel in a non-FDX band.

Example 13 is a modem circuit, including the subject matter of examples 1-12, including or omitting elements, wherein the one or more external channels comprises one or more active DS channels associated with the modem circuit, wherein the active DS channels comprise DS channels that are not in the frozen state.

Example 14 is a modem circuit, including the subject matter of examples 1-13, including or omitting elements, wherein the one or more external channels comprises one or more non-FDX DS channels associated with the modem circuit.

Example 15 is a modem circuit associated with a communication system, comprising a symbol tracking circuit configured to track a symbol timing associated with a downstream (DS) channel associated with the modem circuit, in accordance with a timing offset estimate comprising an internal timing offset derived based on the DS channel, during a normal state associated with the DS channel; and track the symbol timing associated with the DS channel, in accordance with the timing offset estimate comprising a unified timing offset derived based on one or more external channels different from the DS channel, during a freeze state associated with the DS channel.

Example 16 is a modem circuit, including the subject matter of example 15, wherein the symbol tracking circuit is further configured to apply a sample rate correction to a DS signal associated with the DS channel, based on the timing offset estimate comprising the internal timing offset, thereby generating a plurality of sample rate corrected DS samples, during the normal state associated with the DS channel; and apply a frequency correction to the DS signal by processing the plurality of sample rate corrected DS samples, based on a frequency offset estimate comprising an internal frequency offset derived based on the DS channel, thereby generating a plurality of DS output samples, during the normal state associated with the DS channel.

Example 17 is a modem circuit, including the subject matter of examples 15-16, including or omitting elements, wherein the symbol tracking circuit is further configured to apply the sample rate correction to the DS signal associated with the DS channel, based on the timing offset estimate comprising the unified timing offset, thereby generating the plurality of sample rate corrected DS samples, during the freeze state associated with the DS channel; and apply the frequency correction to the DS signal by processing the plurality of sample rate corrected DS samples, based on the frequency offset estimate comprising a unified frequency offset derived based on the one or more external channels, thereby generating the plurality of DS output samples, during the freeze state associated with the DS channel.

Example 18 is a modem circuit, including the subject matter of examples 15-17, including or omitting elements, wherein the symbol tracking circuit comprises a resampling circuit configured to apply the sample rate correction to the DS signal associated with the DS channel, based on the timing offset estimate, thereby generating the plurality of sample rate corrected DS samples; and generate a sample valid signal comprising a plurality of sample valid pulses indicative of a timing when the plurality of sample rate corrected DS samples are to be generated, based on the timing offset estimate; and a phase rotation circuit configured to apply the frequency correction to the DS signal by processing the plurality of sample rate corrected DS samples, based on the frequency offset estimate, thereby generating the plurality of DS output samples.

Example 19 is a modem circuit, including the subject matter of examples 15-18, including or omitting elements, wherein the symbol tracking circuit further comprises a symbol timing circuit configured to track the symbol timing associated with the DS channel based on counting sample valid pulses associated with the sample valid signal from the resampling circuit.

Example 20 is a modem circuit, including the subject matter of examples 15-19, including or omitting elements, wherein the one or more external channels comprises a DS primary channel in a non-FDX band.

Example 21 is a modem circuit, including the subject matter of examples 15-20, including or omitting elements, wherein the one or more external channels comprises one or more active DS channels associated with the modem circuit, wherein the active DS channels comprise DS channels that are not in the frozen state.

Example 22 is a method for a modem circuit associated with a communication system, comprising tracking a symbol timing associated with a downstream (DS) channel associated with the modem circuit, at a symbol tracking circuit, in accordance with a timing offset estimate; wherein the timing offset estimate comprises a unified timing offset derived based on one or more externals channels associated with the modem circuit that is different from the DS channel.

Example 23 is a method, including the subject matter of example 22, further comprising applying a sample rate correction to a DS signal associated with the DS channel, at the symbol tracking circuit, based on the timing offset estimate comprising the unified timing offset, thereby generating a plurality of sample rate corrected DS samples; and applying a frequency correction to the DS signal by processing the plurality of sample rate corrected DS samples, at the symbol tracking circuit, based on a frequency offset estimate comprising a unified frequency offset derived based on the one or more external channels, thereby generating a plurality of DS output samples.

Example 24 is a method, including the subject matter of examples 22-23, including or omitting elements, wherein tracking the symbol timing associated with the DS channel and applying the sample rate correction to the DS signal, based on the timing offset estimate comprising the unified time offset, and applying the frequency correction to the DS signal based on the frequency offset estimate comprising the unified frequency offset, is performed at the symbol tracking circuit, during a freeze state associated with the DS channel.

Example 25 is a method, including the subject matter of examples 22-24, including or omitting elements, wherein tracking the symbol timing associated with the DS channel and applying the sample rate correction to the DS signal is performed at the symbol tracking circuit, based on the timing offset estimate comprising an internal time offset, and applying the frequency correction to the DS signal is performed at the symbol tracking circuit, based on the frequency offset estimate comprising an internal frequency offset, during a normal state associated with the DS channel, wherein the internal time offset and the internal frequency offset are derived based on the DS channel.

While the invention has been illustrated, and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

What is claimed is:

1. A modem circuit associated with a communication system, comprising:
a symbol tracking circuit configured to:
track a symbol timing associated with a downstream (DS) channel associated with the modem circuit, in accordance with a timing offset estimate;
wherein the timing offset estimate comprises a unified timing offset derived based on one or more external channels associated with the modem circuit that is different from the DS channel.

2. The modem circuit of claim 1, wherein the symbol tracking circuit is further configured to:
apply a sample rate correction to a DS signal associated with the DS channel, based on the timing offset estimate comprising the unified timing offset, thereby generating a plurality of sample rate corrected DS samples; and
apply a frequency correction to the DS signal by processing the plurality of sample rate corrected samples, based on a frequency offset estimate comprising a unified frequency offset derived based on the one or more external channels, thereby generating a plurality of DS output samples.

3. The modem circuit of claim 2, wherein the symbol tracking circuit is configured to track the symbol timing associated with the DS channel and apply the sample rate correction to the DS signal, based on the timing offset estimate comprising the unified time offset, and apply the frequency correction to the DS signal based on the frequency offset estimate comprising the unified frequency offset, during a freeze state associated with the DS channel.

4. The modem circuit of claim 3, wherein the symbol tracking circuit is configured to track the symbol timing associated with the DS channel and apply the sample rate correction to the DS signal, based on the timing offset estimate comprising an internal time offset, and apply the frequency correction to the DS signal based on the frequency offset estimate comprising an internal frequency offset, during a normal state associated with the DS channel, wherein the internal time offset and the internal frequency offset are derived based on the DS channel.

5. The modem circuit of claim 4, further comprising an internal recovery loop circuit configured to determine the internal timing offset and the internal frequency offset based on the DS signal associated with the DS channel.

6. The modem circuit of claim 5, wherein the internal recovery loop circuit comprises:
an internal timing recovery loop circuit configured to determine the internal timing offset based on a timing error associated with the DS signal; and
an internal carrier frequency recovery loop circuit configured to determine the internal frequency offset based on a frequency error associated with the DS signal.

7. The modem circuit of claim 5, wherein the internal recovery loop circuit comprises:
an internal timing recovery loop circuit configured to determine the internal timing offset based on a timing error associated with the DS signal; and
a frequency offset determination circuit configured to derive the internal frequency offset based on the internal timing offset, in accordance with a predefined time frequency offset relation.

8. The modem circuit of claim 2, further comprising a unified recovery loop circuit configured to determine the unified timing offset and the unified frequency offset based on DS signals associated with the one or more external channels.

9. The modem circuit of claim 2, wherein the symbol tracking circuit is configured to track the symbol timing associated with the DS channel based on a sample valid signal generated in accordance with the timing offset estimate.

10. The modem circuit of claim 9, wherein the symbol tracking circuit comprises:
a resampling circuit configured to:
apply the sample rate correction to the DS signal associated with the DS channel, based on the timing offset estimate, thereby generating the plurality of sample rate corrected DS samples; and
generate the sample valid signal comprising a plurality of sample valid pulses indicative of a timing when the plurality of sample rate corrected DS samples are to be generated, based on the timing offset estimate; and
a phase rotation circuit configured to apply the frequency correction to the DS signal by processing the plurality of sample rate corrected DS samples, based on the frequency offset estimate, thereby generating the plurality of DS output samples.

11. The modem circuit of claim 10, wherein the symbol tracking circuit further comprises a symbol timing circuit configured to track the symbol timing of the DS channel based on counting the plurality of sample valid pulses associated with the sample valid signal from the resampling circuit.

12. The modem circuit of claim 1, wherein the one or more external channels comprises a DS primary channel in a non-FDX band.

13. The modem circuit of claim 1, wherein the one or more external channels comprises one or more active DS channels associated with the modem circuit, wherein the active DS channels comprise DS channels that are not in the frozen state.

14. The modem circuit of claim 1, wherein the one or more external channels comprises one or more non-FDX DS channels associated with the modem circuit.

15. A modem circuit associated with a communication system, comprising:
a symbol tracking circuit configured to:
track a symbol timing associated with a downstream (DS) channel associated with the modem circuit, in accordance with a timing offset estimate comprising an internal timing offset derived based on the DS channel, during a normal state associated with the DS channel; and
track the symbol timing associated with the DS channel, in accordance with the timing offset estimate comprising a unified timing offset derived based on one or more external channels different from the DS channel, during a freeze state associated with the DS channel.

16. The modem circuit of claim 15, wherein the symbol tracking circuit is further configured to:
apply a sample rate correction to a DS signal associated with the DS channel, based on the timing offset estimate comprising the internal timing offset, thereby generating a plurality of sample rate corrected DS samples, during the normal state associated with the DS channel; and
apply a frequency correction to the DS signal by processing the plurality of sample rate corrected DS samples, based on a frequency offset estimate comprising an internal frequency offset derived based on the DS channel, thereby generating a plurality of DS output samples, during the normal state associated with the DS channel.

17. The modem circuit of claim 16, wherein the symbol tracking circuit is further configured to:
apply the sample rate correction to the DS signal associated with the DS channel, based on the timing offset estimate comprising the unified timing offset, thereby generating the plurality of sample rate corrected DS samples, during the freeze state associated with the DS channel; and
apply the frequency correction to the DS signal by processing the plurality of sample rate corrected DS samples, based on the frequency offset estimate comprising a unified frequency offset derived based on the one or more external channels, thereby generating the plurality of DS output samples, during the freeze state associated with the DS channel.

18. The modem circuit of claim 17, wherein the symbol tracking circuit comprises:
a resampling circuit configured to:
apply the sample rate correction to the DS signal associated with the DS channel, based on the timing offset estimate, thereby generating the plurality of sample rate corrected DS samples; and
generate a sample valid signal comprising a plurality of sample valid pulses indicative of a timing when the plurality of sample rate corrected DS samples are to be generated, based on the timing offset estimate; and
a phase rotation circuit configured to apply the frequency correction to the DS signal by processing the plurality of sample rate corrected DS samples, based on the frequency offset estimate, thereby generating the plurality of DS output samples.

19. The modem circuit of claim 18, wherein the symbol tracking circuit further comprises a symbol timing circuit configured to track the symbol timing associated with the DS channel based on counting sample valid pulses associated with the sample valid signal from the resampling circuit.

20. The modem circuit of claim 15, wherein the one or more external channels comprises a DS primary channel in a non-FDX band.

21. The modem circuit of claim 15, wherein the one or more external channels comprises one or more active DS channels associated with the modem circuit, wherein the active DS channels comprise DS channels that are not in the frozen state.

22. A method for a modem circuit associated with a communication system, comprising:
tracking a symbol timing associated with a downstream (DS) channel associated with the modem circuit, at a symbol tracking circuit, in accordance with a timing offset estimate;
wherein the timing offset estimate comprises a unified timing offset derived based on one or more externals channels associated with the modem circuit that is different from the DS channel.

23. The method of claim 22, further comprising:
applying a sample rate correction to a DS signal associated with the DS channel, at the symbol tracking circuit, based on the timing offset estimate comprising the unified timing offset, thereby generating a plurality of sample rate corrected DS samples; and
applying a frequency correction to the DS signal by processing the plurality of sample rate corrected DS samples, at the symbol tracking circuit, based on a frequency offset estimate comprising a unified frequency offset derived based on the one or more external channels, thereby generating a plurality of DS output samples.

24. The method of claim 23, wherein tracking the symbol timing associated with the DS channel and applying the sample rate correction to the DS signal, based on the timing offset estimate comprising the unified time offset, and applying the frequency correction to the DS signal based on the frequency offset estimate comprising the unified frequency offset, is performed at the symbol tracking circuit, during a freeze state associated with the DS channel.

25. The modem circuit of claim 24, wherein tracking the symbol timing associated with the DS channel and applying the sample rate correction to the DS signal is performed at the symbol tracking circuit, based on the timing offset estimate comprising an internal time offset, and applying the frequency correction to the DS signal is performed at the symbol tracking circuit, based on the frequency offset estimate comprising an internal frequency offset, during a normal state associated with the DS channel, wherein the internal time offset and the internal frequency offset are derived based on the DS channel.
